(19) United States
(12) Patent Application Publication
(10) Pub. No.: US 2013/0217487 A1
(43) Pub. Date: Aug. 22, 2013

(54) CHARACTER IMAGE PROJECTION METHODS AND SYSTEMS

(71) Applicant: SG LABS, LLC, (US)

(72) Inventors: Rory T. SLEDGE, O'Fallon, IL (US); Michael S. GRAMELSPACHER, Greenfield, IL (US)

(73) Assignee: SG LABS, LLC, O'Fallon, IL (US)

(21) Appl. No.: 13/736,584

(22) Filed: Jan. 8, 2013

Related U.S. Application Data
(60) Provisional application No. 61/600,023, filed on Feb. 17, 2012.

(51) Int. Cl. A63F 13/00

(52) U.S. Cl. CPC A63F 13/00
USPC 463/31

(57) ABSTRACT

Methods and systems for character image projection are described. In one embodiment, a first character image associated with a first character attribute may be projected. The first character image includes a first graphical representation of a character. The first character attribute may represent a character status of the character in the first character image. A second character attribute is selected based on a character instruction. The second character attribute may represent a changed character status of the character in the second character image.

A second character image from the mobile electronic device may be projected based on selection of the second image attribute. Additional methods and systems are disclosed.

### CROSS-REFERENCE TO RELATED APPLICATIONS

This application claims the benefit of U.S. Provisional Application No. 61/600,023, filed on 17 Feb. 2012. A claim of priority is made.

### FIELD

This application relates to methods and systems for image projection and more specifically to methods and systems to project characters from a mobile electronic projection device.

### BACKGROUND

Flashlights project light onto surfaces such as walls. Certain flashlights have lens with drawings of cartoon characters or other characters that cause a static image of these characters to appear on the wall. These flashlights project a different image when the lens with the drawing is physically replaced with another lens with a different drawing.

### BRIEF DESCRIPTION OF THE DRAWINGS

FIG. 1 is a block diagram of a character imaging system, according to an example embodiment;

FIG. 2 is a block diagram of a mobile electronic projection device that may be deployed within the character imaging system of FIG. 1, according to an example embodiment;

FIG. 3 is a block diagram of a projection unit that may be deployed within the mobile electronic projection device of FIG. 1, according to an example embodiment;

FIG. 4 is a block diagram of an electronic play set that may be deployed within the character imaging system of FIG. 1, according to an example embodiment;

FIG. 5 is a block diagram of a mobile electronic projection device that may be deployed within the character imaging system of FIG. 1, according to an example embodiment;

FIG. 6 is a block diagram of an electronic play set that may be deployed within the character imaging system of FIG. 1, according to an example embodiment;

FIG. 7 is a block diagram of a character imaging subsystem that may be deployed within the mobile electronic projection device of FIGS. 2 and 5, according to an example embodiment;

FIGS. 8 and 9 are block diagrams of methods for character image projection, according to example embodiments; and

FIG. 10 is a block diagram of a machine in the example form of a computer system within which a set of instructions for causing the machine to perform any one or more of the methodologies discussed herein may be executed.

### DETAILED DESCRIPTION

Example methods and systems for character image projection are described. In the following description, for purposes of explanation, numerous specific details are set forth in order to provide a thorough understanding of example embodiments. It will be evident, however, to one of ordinary skill in the art that embodiments of the invention may be practiced without these specific details.

In general, a mobile electronic device uses an internal projector to project an image of a character onto a surface. The projected character image changes to reflect user interaction with the mobile electronic device. In some embodiments, the character is projected onto a surface of an electronic play set. The electronic play set may provide data to the mobile electronic device that may be used by the mobile electronic device to select a further image of the character to project.

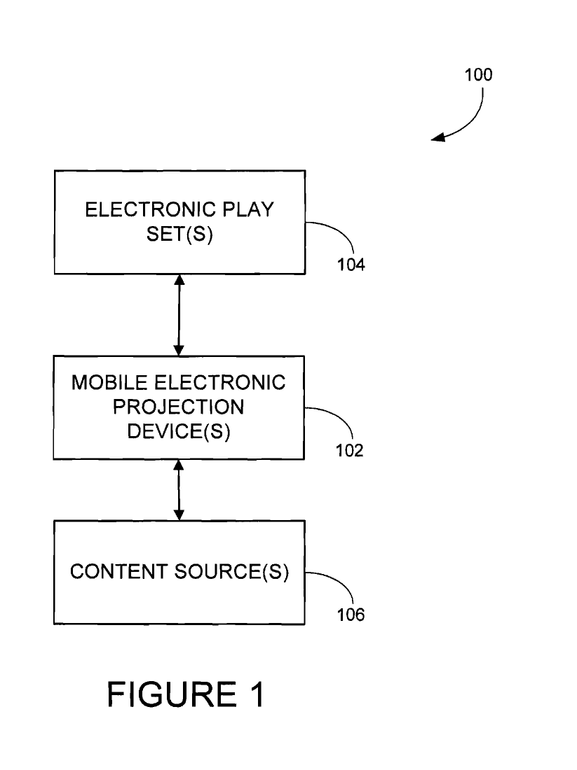

FIG. 1 illustrates a character imaging system 100 that enables a user to project a character image from a mobile electronic projection device 102. The character imaging system 100 may include an electronic play set 104, a content source 106, or both. The mobile electronic projection device 102 may be used without interacting or otherwise communicating with other devices, or may be used in combination with other electronic mobile projection devices 102, electronic play sets 104, and/or content sources 106.

The projected character images may be a single image or a series of images in the form of an animation. Examples of the character include fantasy characters (e.g., fairies and princesses), animals (e.g., dinosaurs, cats, and dogs), bugs, bunnies, butterflies, robots, monsters, cars, dolls, pets, airplanes, and boats. Other characters may also be projected from the mobile electronic projection device 102.

The character may be associated with the mobile electronic projection device 102 when the user first receives the mobile electronic projection device 102. The user may select the character before, during, or after purchase of the device. The user may import the character from a computing system (e.g., a computer or a gaming device such as a NINTENDO WII). As part of the importation, an image or attributes of the character may be recognized and associated with character attributes for the character.

A single character or multiple characters may be associated with the mobile electronic projection device 102. For example, the user may select a particular character among multiple available characters.

In some embodiments, the images of the character may be prestored, pregenerated, or pre-rendered on the electronic mobile projection devices 102. In other embodiments, the character images are generated or rendered on the electronic mobile projection devices 102.

In general, the character that is projected from the mobile electronic projection device 102 has a character attribute that is used to track or modify the appearance of the projected image of the character. For example, a character attribute may be associated with a physical attribute of the character, indicate a position of the character in a character image, a geographic location of the character, a pose of the character, an association of a background with the character, an association of an item with the character, an item status of the item associated with the character, or a time of day associated with the character. Other character attributes may also be used. A single character attribute or multiple character attributes may be associated with the character. For example, multiple character attributes may reflect the hair color, hair length, eyes, clothing, body style, or the like of the character. The single character attribute or multiple character attributes may be used in determining the character image of the character to be projected from the mobile electronic projection device 102.

By way of example, a first character attribute indicates that the character is at a candy shop, a second character attribute indicates that the character has a lollipop, and a third character attribute indicates that the character has four licks of the lollipop remaining.

In some embodiments, character attributes or other data stored on the mobile electronic projection device 102 may be unlocked based on certain events. For example, after a period of time, the character attribute may reflect that the character is now older. By having the mobile electronic projection device 102 present at a particular place, the character may have enhanced functionality based on the unlocking of a new character attribute. Other character attributes or other data may be unlocked on the mobile electronic projection device 102.

The mobile electronic projection device 102 is generally portable to enable a person to easily carry and manipulate the mobile electronic projection device 102. The mobile electronic projection device 102 may be hand-held, wearable, or fixed in a stand. The shape of the mobile electronic projection device 102 may encourage device interaction. For example, the mobile electronic projection device 102 may be in the shape of a wand, a bat, a club, a sword, a tower, a robot, a pair of glasses, a pendant, or the like.

The mobile electronic projection device 102 may project the character onto a surface (e.g., of an object). The surface may be the surface of the electronic play set 104 or an object not capable of interaction (e.g., a wall, a desktop of a desk, or a sheet).

The electronic play set 104 is an external interaction unit with which a single mobile electronic projection device 102 or multiple electronic mobile projection devices 102 may interact. The electronic play set 104 may be in the form or simulated form of a mirror, a candy store, a piece of playground equipment or a playground, a dress shop or clothing store, a department store, a beauty shop, a fighting ring, or the like. For example, the electronic play set 104 may in the simulated form of a minor may include a piece of plastic with a sticker that gives the piece of plastic a simulated look of a minor.

In some embodiments, the electronic play set 104 polls to determine whether it has received a play set query from the mobile electronic projection device 102. The polling can be constant, at regular or irregular interval, or otherwise. When the electronic play set 104 receives a play set query, the electronic play set 104 transmits a play set response. The play set response includes a character instruction, a play set identifier, or both. In some embodiments, the play set identifier is a unique identifier that specifically identifies the electronic play set 104. In other embodiments, the play set identifier is a common identifier that is used for all electronic play sets 104 that are of the same type. The play set response, in some embodiments, includes input information, output information, or both. The play set identifier identifies the type of electronic play set 104.

By way of example, the user may aim the mobile electronic projection device 102 at the electronic play set 104 so that the projected character image appears on or near the play set. The mobile electronic projection device 102, as part of the projected image or separate from the projected image, transmits a play set query to the electronic play set 104. The electronic play set 104 receives the play set query and transmits a play set message back to the mobile electronic projection device 102. The mobile electronic projection device 102, upon receiving the play set message, projects an image of the character that depicts the character relative to the electronic play set 104. For example, the image may show the character interacting with the electronic play set 104.

In some embodiments, the electronic play set 104 may distinguish between different mobile electronic projection devices 102. In other embodiments, the electronic play set 104 may not distinguish between different mobile electronic projection devices 102.

Multiple mobile electronic projection devices 102 may use the electronic play set 104 for interaction. The electronic play set 104 may receive an interaction request from a first character and interact with a second character based on the interaction request.

The interaction may include bartering or exchange. The battering may enable a character associated with one mobile electronic projection device 102 to have an exchange with the character associated with another mobile electronic projection device 102. For example, an item associated with one character may be bartered for a different item associated with another character. The items may be good, character accessories, or the like. Other types of items may be bartered.

The interaction may include character interaction. For example, a first user associated with a first character may request that the first character kick or punch a second character. Other types of interaction may occur.

The electronic play set 104 may track certain information. The information may include item availability, past interaction with characters, and the like. For example, the electronic play set 104 in the form of a candy store may track availability of a certain number of lollipops for each available lollipops type.

Multiple mobile electronic projection devices 102 may interact without using the electronic play set 104. For example, character images from the mobile electronic projection devices 102 may be projected onto a same surface an interaction may occur directly between the devices without use of the electronic play set 104.

The electronic play set 104 may interact with multiple mobile electronic projection devices 102 through a broadcast or party mode. The group mode may be entered by receiving a request from a particular mobile electronic projection device 102, receiving a user request on the electronic play set 104 for broadcast mode, or group mode may be entered into otherwise.

The electronic play set 104 in the broadcast mode may transmit the play set message to all mobile electronic projection devices 102 within range (e.g., in a room). The characters associated with the multiple mobile electronic projection devices 102 in the room may act accordingly based on a changed or new character attribute. In some embodiments, only the mobile electronic projection devices 102 that match a certain group code included in the broadcast play set message may react in response to receipt of the play set message. In some embodiments, the broadcast mode may enable the multiple mobile electronic projection devices 102 to participate in a game. For example, a hide and seek game, a scavenger hunt game, or a different type of game may be plated with the electronic play set 104 in broadcast mode. During the course of the game, electronic play set 104 may return to normal mode and transmit the play set message to a specific mobile electronic projection device 102. For example, the play set message may be sent to the specific mobile electronic projection device 102 to provide a notification that the character associated with the mobile electronic projection device 102 has won the game.

In some embodiments, functionality (e.g., character attributes) of the mobile electronic projection device 102 may be unlocked based on recognition of the ability of the user of the mobile electronic projection device 102, the age of the user, or the like.

The mobile electronic projection device 102 may be set in a fixed position for a period of time (e.g., during game play). The fixed position may enable the mobile electronic projection device 102 to project a character or non-character image on the surface from a known distance. The mobile electronic projection device 102 may remain in the fixed position by use of a clamp, a docking station, or other type of fixation device. While in the fixed position, the mobile electronic projection device 102 may project a series of images to enable teaching, game play, or the like. For example, the series of images may teach the user how to make a certain drawing, to teach letter or word recognition, to teach item recognition, or the like. In some embodiments, certain functionality of the mobile electronic projection device 102 is only enabled while the mobile electronic projection device 10 is in the fixed position.

The images projected from the mobile electronic projection device 102 may be projected onto a smart board. The projected image may be overlaid on the smart board. When the user interacts with the smart board, the information may then be provided back to the mobile electronic projection device 102 through a sync interface.

The content source 106, when included in the character imaging system 100, provides content to the mobile electronic projection device 102. In some embodiments, the content may be provided from the content source 106 to the mobile electronic projection device 102 through a cartridge, a synch, or otherwise. In some embodiments, the content is stored on the mobile electronic projection device 102 prior to providing a user with the device. The provided content may be a series of character images, portions of character images, or content used to generate character images.

In general, the content source 106 is located in a physical or online store that enables new characters to be purchased, existing characters to be modified, or the like. The associated content with the new or modified character may then be provided to the mobile electronic projection device 102. In some embodiments, the content source 106 and the electronic play set 104 may be combined into a single device.

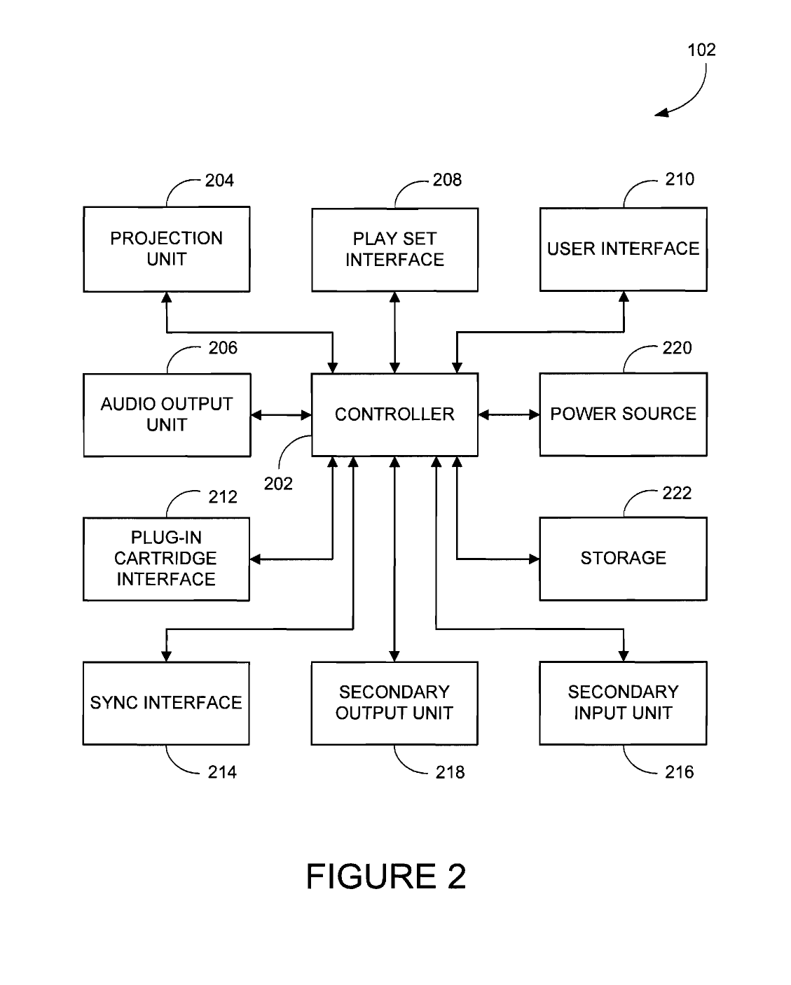

FIG. 2 illustrates an example mobile electronic projection device 102 that may be deployed in the system 100 (see FIG. 1), or otherwise deployed in another system. The mobile electronic projection device 102 is shown to include a controller 202, a projection unit 204, an audio output unit 206, a play set interface 208, a user interface 210, a plug-in cartridge interface 212, a sync interface 214, a secondary input unit 216, a secondary output unit 218, a power source 220, and a storage 222. Other or different components may be included.

In general, the controller 202 acts as a data processing and control unit that is communicatively coupled with and directs operation of the different components 204-222. The functionality and characteristics of the controller 202 deployed in the mobile electronic projection device 102 may be based on whether the mobile electronic projection device 102 generates character images based on received or stored content or retrieves character images for projection from the storage 222. Examples of the controller 202 include microcontrollers, microprocessors, and the like.

Light is projected from the mobile electronic projection device 102 by use of the projection unit 204. The light, when projected on a surface, causes a character image to fall on the surface. The projection unit 204 may use a LED backlight, a modulated laser backlight, a Digital Light Processing (DLP), or another light source to project the character image. In general, the light projected from the projection unit 204 is a narrow light beam. An example of the projection unit 204 is described in greater detail below.

Audible alerts or feedback may be provided on the mobile electronic projection device 102 through the audio output unit 206. Examples of the audio output unit 206 include a tone generator, a speaker, voice and sound effects functionality, an audio output jack (e.g., a ⅛ inch jack to receive an audio connection from headphones), or the like.

The play set interface 208 is an electronic communicator that enables the mobile electronic projection device 102 to communicate with the electronic play set 104. The play set interface 208 may be an infrared (IR) transceiver, a radio frequency (RF) transceiver, a magnetic conductor, an electronic conductor, or a different type of interface. In some embodiments, the play set interface 208 has direction finding capability to ensure orientation of the mobile electronic projection device 102 towards the electronic play set 104.

In some embodiments, the play set interface 208 may be made integral with the projection unit 204. For example, the light projected from the projection unit 204 may be modulated with visible, substantially invisible, or invisible data.

The user interface 210 is generally included with the mobile electronic projection device 102 to enable the user to control the mobile electronic projection device 102. The mobile electronic projection device 102 may include a single user interface or multiple user interfaces.

In some embodiments, the user interface includes a four-way directional pad and an action button. The action button may be located in the middle of the directional pad, outside of the directional pad, in proximity to the directional pad, or otherwise located on the mobile electronic projection device 102. The action button may be an enter button, a go button, or the like.

By way of example, when the user actuates a right button the character will animate, turn to the right, and fly to the right. When the user releases the right button, the character will animate, return to the center, and stand still. When the user actuates a left button the character will animate, turn to the left, and fly to the left. When the user actuates a down button, the character will fly back to the user and be bigger. When the user actuates an up button, the character will fly away from the user and then turn back to the camera. When the user actuates an action button, the character will do a flip.

In some embodiments, the user interface 210 includes a joystick, a trackball, or a directional button. In some embodiments, the user interface 210 includes a tilt or shake sensor, an accelerometer, or the like. The character may then respond to movement of the mobile electronic projection device 102. In some embodiments, the user interface 210 includes a voice interface. The character may then respond to the sound of the user's voice or the words spoken by the user. Other types of interfaces may also be used as the user interface 210.

The content that may be used as or with the character image may be loaded on the mobile electronic projection device 102 prior to use, the content may be generated during use or before use, or the content may be obtained otherwise. The content may be loaded through a cartridge connected to the plug-in cartridge interface 212, a computer interface (e.g., a USB interface) connected to the sync interface 214, or the like. The content may be obtained in a physical store, downloaded through a computer network, or otherwise obtained.

In general, the cartridge plugged into the plug-in cartridge interface 212 is a read-only cartridge. However, other types of cartridges including cartridges capable of storage may also be used. The cartridge may provide content or other data to the mobile electronic projection device 102.

The sync interface 214 may receive content or other data through a variety of networking interfaces including Firewire, USB, parallel, serial, Ethernet, Apple Desktop Bus, MIDI, eSATA, DVI, HDMI, or the like. The sync interface 214 may receive data from a variety of flash memory or other types of interfacing cards including CompactFlash, MultiMediaCard, RS-MMC, xD-Picture Card, SD cards, miniSD Cards, microSD Cards, Gruvi DRM memory cards, Memory Stick, Memory Stick PRO (2003), Memory Stick Duo, Memory Stick Pro Duo, Memory Stick PRO-HG Duo, Memory Stick Micro, or the like. The content may then be stored in the storage 222 or otherwise used.

In some embodiments, the sync interface 214 may enable interaction with a computing system. Some or all of the character attributes of the character or other information regarding the character may be uploaded to the computing system. A portion or all of the uploaded character attributes may then be modified. The modifications may then be provided back to the mobile electronic projection device 102 through the sync interface 214. For example, an image of the character may be shown on a display of the computer system. The user may purchase a new outfit for the character or change the hair color of the character on the computing system. The updated character attribute associated with the clothing of the character or the hair color may be provided to the mobile electronic projection device 102 through the sync interface 214.

Certain character attributes of the character may be modifiable in certain situations. For example, certain character attributes may only be modified with the computing system, and other character attributes may only be modified when interacting with certain electronic play sets 104.

Through use of the sync interface 214 and the projection unit 204, the user may interact with the same character in both the computing system as a generated image and in the real word as a projected image. In some embodiments, the movement of the character between the computing system and the mobile electronic projection device 102 may be synchronized.

The plug-in cartridge interface 212, the sync interface 214, or both may be deployed within the mobile electronic projection device 102 to enable the mobile electronic projection device 102 to receive content or other data. In some embodiments, a switch may enable a user to select between the interfaces 212, 214. In some embodiments, one of the interfaces 212, 214 may be used in a certain locations (e.g., a special store) and the other of the interfaces 212, 214 may be used in other locations (e.g., a user's home).

Input may be received on the mobile electronic projection device 102 through the secondary input unit 216 without interaction from the user. In one embodiment, the secondary input unit 216 is a temperature sensor that can react based on the detected temperature. For example, the appearance of character may change based on a warm or cool temperature. In one embodiment, the secondary input unit 216 is an ambient light detector. For example, the controller 202 could turn a backlight of the projection unit 204 brighter or dimmer based on the amount of ambient light detected. In one embodiment, the secondary input unit 216 is an internal clock. For example, the appearance of character may change based on time of day according to the internal clock. Other types of secondary input units 216 may be used. A single secondary input unit 216 or multiple secondary input units 216 may be included with the mobile electronic projection device 102.

In some embodiments, the secondary input unit 216 may include an image sensor capable of optical recognition. For example, the image sensor may enable recognition while the mobile electronic projection device 102 is in the fixed position.

The secondary output unit 218 may be used to provide output beyond the character image projected from the projection unit 204. In general, the secondary output unit 218 provides output that is not part of the image projected by the projection unit 204.

In some embodiments, the secondary output unit 218 converts information received from the controller 202 into visual information. The display 906 may include light emitting diodes (LEDs), an array of LEDs, an array of collections of LEDs or multicolor LEDs, a color, monochrome, grayscale or field sequential liquid crystal display (LCD), vacuum florescent display (VFD), organic LED (OLED) display, electronic ink (e-ink) display, projector or any other system capable of representing visual information.

In some embodiments, the secondary output unit 218 converts information received into non-visual data. For example, the secondary output unit 218 may provide auditory output such as a buzzer, speaker, piezo element, or other electro-mechanical sounding element. The secondary output unit 218 may provide tactile output such as an offset motor, vibrator motor, electric shock, force feedback or gyroscopic forces. The secondary output unit 218 may provide connectivity to an external system via wired or wireless data interface.

Other types of secondary output units 218 may be used. A single secondary output unit 218 or multiple secondary output units 218 may be included with the mobile electronic projection device 102.

The power source 220 may include batteries, solar cells, or the like. In general, the power source 220 is a low capacity power source that is self-contained. However, other types of sources of power may also be used as the power source 220.

The storage 222 may include volatile memory, non-volatile memory, or both. For example, the volatile memory may be system RAM and the non-volatile memory may be EPROM. Other kinds of storage may also be used.

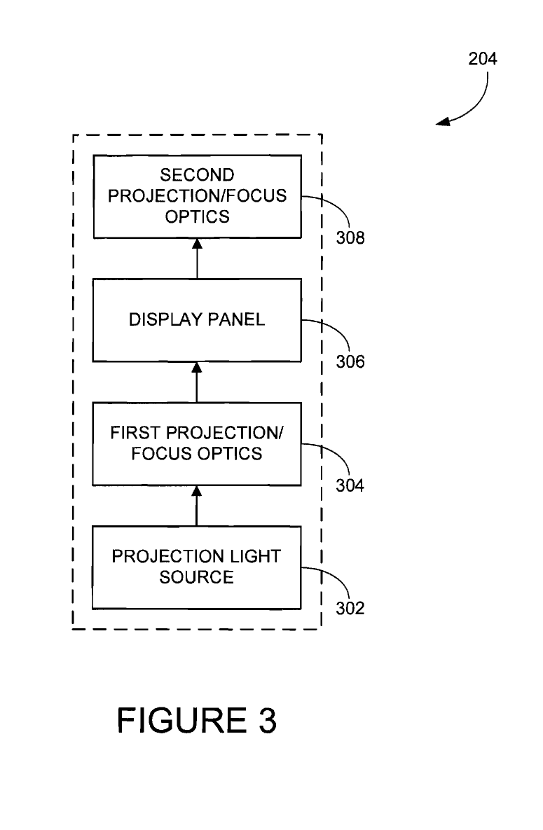

FIG. 3 illustrates an example projection unit 204 that may be deployed in the mobile projection device 102 (see FIG. 1), or otherwise deployed in another device. The projection unit 204 is shown to include a projection light source 302, a first projection/focus optics 304, a display panel 306, and the second projection/focus optics 308. Other or different components may be included.

The projection light source 302 provides a light that is capable of projection. The projection light source 302 is typically white LED or other source of white light. However, other colored light sources and source types may be used. In one embodiment, the projection light source 302 is a halogen light source. In some embodiments, the projection light source 302 is a high efficiency high brightness light source.

In some embodiments, the controller 202 controls the amount of light projected by the projection light source 302. In other embodiments, the amount of light projected by the projection light source 302 is constant. In other embodiments, the secondary input unit 216 controls the amount of light projected by the projection light source 302 (see FIG. 2).

In one embodiment, the projection light source 302 is approximately ¼ of a watt. In one embodiment, the projection light source 302 is approximately ½ of a watt. In one embodiment, the projection light source 302 is approximately one watt. Higher or lower wattage may be used.

The light projected from the projection light source 302 to the first projection/focus optics 304. In general, the first projection/focus optics 304 is a standard profusion lens arrangement. In some embodiments, the first projection/focus optics 304 is manually variable focus optics to enable projection of the character image at a variety of distances. In some embodiments, the first projection/focus optics 304 is fixed focus to enable projection of the character image at a preset distance.

After traveling through the first projection/focus optics 304, the projected light travels through the display panel 306 to associate the light with a character generated on the display panel 306. In some embodiments, the display panel 306 is an LCD. The display panel 306, when an LCD, is generally a low-end, low-resolution color LCD screen. The LCD screen may be color LCD screen, a black and white LCD screen, or a grayscale LCD screen. For example, a 64,000 color transmissive TFT LCD panel may be used. In some embodiments, the display panel 306 is a transparent overlay. Other types of components used for image projection may also be used.

The light passing through the display panel 306 is then focused through the second projection/focus optics 308 to enable projection of the character image. The second projection/focus optics 308 generally includes the same types of optics as the first projection/focus optics 304. The optics 304, 308 may work in tandem with one another in the projection unit 204.

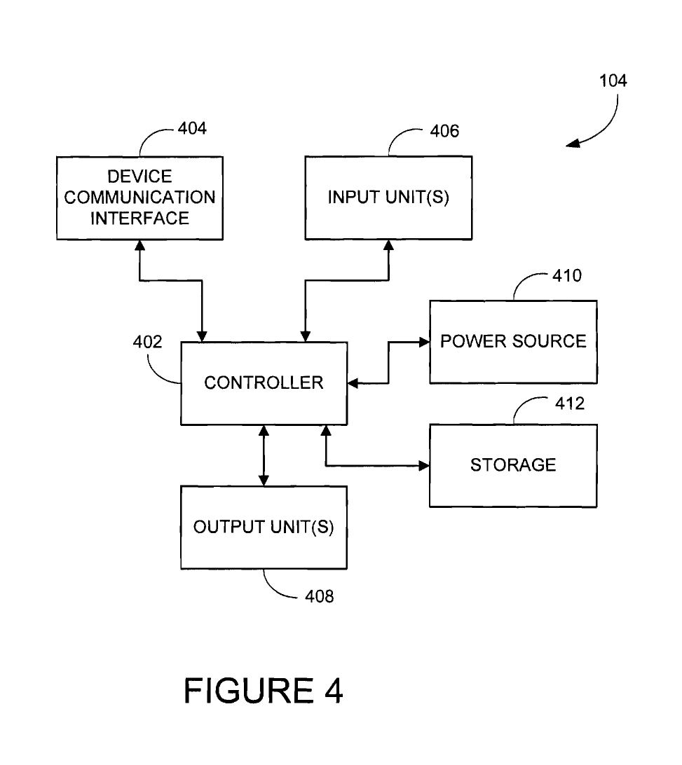

FIG. 4 illustrates an example electronic play set 104 that may be deployed in the system 100 (see FIG. 1), or otherwise deployed in another system. The electronic play set 104 is shown to include a controller 402, a device communication interface 404, an input unit 406, an output unit 408, a power source 410, and a storage 412. Other or different components may be included.

In general, the controller 402 acts as data processing and control unit that is communicatively coupled with and directs operation of the different components 404-412. Examples of the controller 402 include microcontrollers, microprocessors, and the like.

The electronic play set 104 communicates with the mobile electronic projection device 102 through the device communication interface 404. The communication may be single direction from the electronic play set 104 to the mobile electronic projection device 102 or bidirectional between the electronic play set 104 and the mobile electronic projection device 102.

The device communication interface 404 may be an infrared (IR) transceiver, a radio frequency (RF) transceiver, a magnetic conductor, an electronic conductor, or a different type of interface. In general, the device communication interface 404 communicates with the mobile electronic projection device 102 through the play set interface 208. In some embodiments, the device communication interface 404 and the play set interface 208 are the same component type. In other embodiments, the device communication interface 404 and the play set interface 208 are different component types.

In some embodiments, the device communication interface 404 of the electronic play set 104 is an active sensor. The active sensor enables one-way or two-way communication with the mobile electronic projection device 102. In some embodiments, the active sensor is in the same channel as the projected image. For example, data may be embedded in the projected image and received by a photodetector of the electronic play set 104. The embedded data may then be extracted from the projected image on the electronic play set 104. In other embodiments, the active sensor is in a different channel than the projected image. For example, the active sensor may be IR or RF.

The input unit 406, when included with the electronic play set 104, enables a user, other person, or outside device to control or otherwise provide input to the electronic play set 104. The electronic play set 104 may include a single user input or multiple user inputs. The input unit 406 enables additional interaction with the electronic play set 104.

In some embodiments, the input unit 406 includes a single button or multiple buttons. By way of example when the electronic play set 104 is a candy store, a first button may be associated with a lollipop, a second button may be associated with an ice cream cone, and a third button may be associated with a cupcake.

The buttons may be pushed prior to the projected character image being shown on the electronic play set 104, while the projected image is being shown on the electronic play set 104, or after the projected image has been down on the electronic play set 104. In general, once the button is pressed, the next mobile electronic projection device 102 that interacts with the electronic play set 104 can have the benefit of the button having been pressed.

By way of example, the electronic play set 104 may include multiple buttons and may detect that a particular button has been pressed. When the electronic play set 104 is a candy shop, a determination can be made by the controller 402 whether any lollipops are remain in the candy shop. If there are lollipops remaining, a lollipop can be made available to the character. When the play set sends a message as described above, the projected image may show then character with the lollipop at the candy shop.

In some embodiments, the input unit 406 includes an orientation sensor to determine if the electronic play set 104 is in the proper position. In some embodiments, the input unit 406 receives an input from an external or integrated device such as an alarm clock or temperature sensor.

The output unit 408 converts information received from the controller 402 into visual information, nonvisual information, or both.

In some embodiments, the output unit 408 provides external control. For example, the output unit 408 may be used to activate a switch (e.g., turn off a bedroom lamp).

The power source 410 may include batteries, solar cells, or the like. In general, the power source 410 is a low capacity power source that is self-contained. However, other types of sources of power may also be used as the power source 220.

The storage 412 may include volatile memory, non-volatile memory, or both. For example, the volatile memory may be system RAM and the non-volatile memory may be EPROM. Other kinds of storage may also be used.

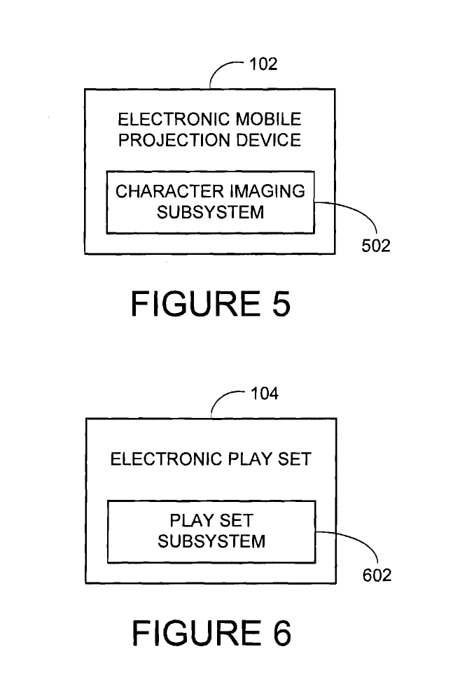

FIG. 5 illustrates an example mobile electronic projection device 102 that may be deployed in the system 100 (see FIG. 1), or otherwise deployed in another system. The mobile electronic projection device 102 is shown to include a character subsystem 502. The character subsystem 502 projects character images. In one embodiment, the character subsystem 502 is deployed within the storage 222 and executed by the controller 202. In some embodiments, the character subsystem 502 is deployed within the storage 222 and executed by the controller 202.

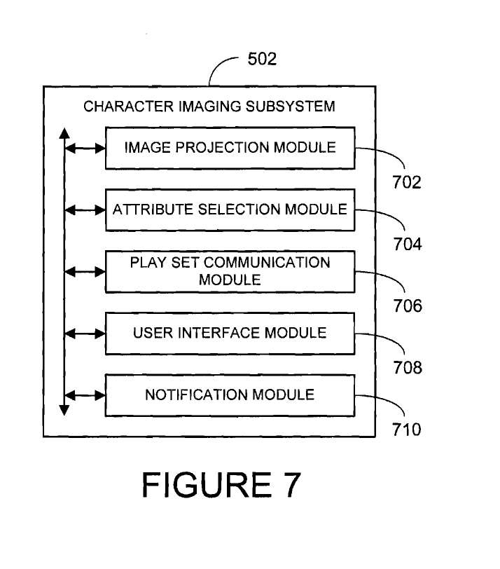

FIG. 6 illustrates an example electronic play set 104 that may be deployed in the system 100 (see FIG. 1), or otherwise deployed in another system. The electronic play set 104 is shown to include a play set subsystem 602. The play set subsystem 602 transmits play set messages to the mobile electronic projection devices 102. In one embodiment, the play set subsystem 602 is deployed within the storage 412 and executed by the controller 402.

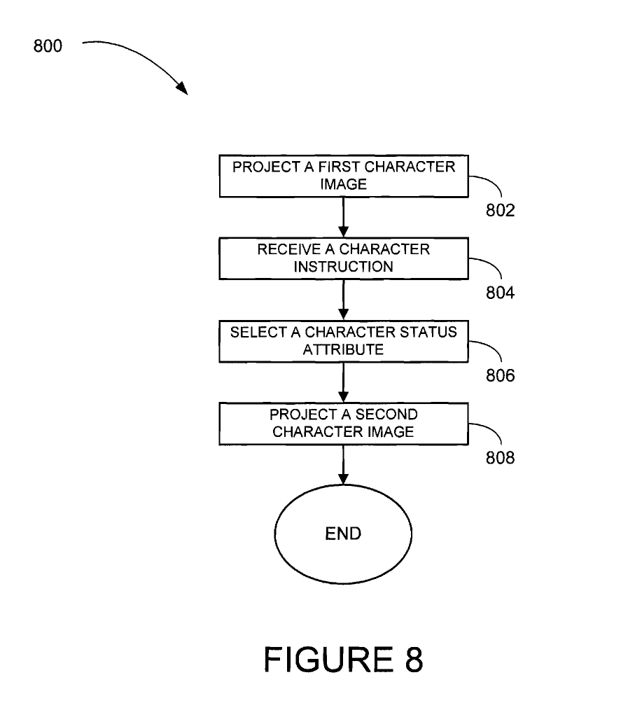

FIG. 7 illustrates a character subsystem 502 that may be deployed in the mobile electronic projection device 102 (see FIG. 1), or otherwise deployed in another system. One or more modules are communicatively coupled and included in the character subsystem 502 to enable projection of a character image. The modules of the character subsystem 502 that may be included are an image projection module 702, an attribute selection module 704, a play set communication module 706, user interface module 708, and a notification module 710. Other modules may also be included. In some embodiments, the modules of the character subsystem 502 may be distributed so that some of the modules are deployed in the electronic device 102 and others are deployed in another device.

A character image including a graphical representation of the character is projected from the image projection module 702. The projected character image is associated with a character attribute. The character attribute represents a character status of the character in the character image. A single character attribute or multiple character attributes may be associated with the character image.

In some embodiments, multiple character attributes may be tracked by use of a table. For example, the table may include entries for character geographic location, character image position, item association, and item status. Other data structures may also be used to track character attributes.

The character status may include, by way of example a position of the character in the first character image, a geographic location of the character, a pose of the character, an association of a background with the character, an association of an item with the character, an item status of the item associated with the character, or the like.

The attribute selection module 704 selects the character attribute based on a character instruction. When the attribute selection module 704 selects a new character attribute, the image projection module 702 displays a new character image based on the new character attribute.

The selection by the attribute selection module 704 may alter or modify an existing character attribute, replace an existing character attribute with a new character attribute, or add a new character attribute to a profile of the character. The selection of the character attribute may affect a single existing character attribute or multiple existing character attributes associated with the character.

By receiving multiple character instructions and modifying the character attribute associated with the character based on the instructions, different character images may be selected or generated and then projected by the image projection module 702. In some embodiments, the projection of different character images without changing lens on the mobile electronic projection device 102 may enable the user to experience greater interactivity with the character.

The play set communication module 706 may enable one or two way communication with the electronic play set 104. In some embodiments, the play set query may be transmitted from the play set communication module 706 to the play set 106 and, the play set message is received from the electronic play set 104 in response. In general, the play set query requests interaction between the mobile electronic projection device 102 and the electronic play set 104. Examples of interaction include an item request to receive an item (e.g., a toy), a barter request (e.g., to exchange an item with the character of another user), or an interactive request to interact with the electronic play set 104. Other types of interactions may occur. In other embodiments, the play set message is received from the electronic play set 104 without transmission of the play set query.

The play set message includes the character instruction, a play set identifier, or both. The attribute selection module 704 may use another character instruction based on the play set message to select another character attribute. The image projection module 702 may then display a new character image based on the selected character attribute.

User interactions may be received from the user through the user interface module 708. In some embodiments, the user interface module 708 receives the character instruction and the character attribute is selected is by the attribute selection module 704 based on receipt of the character instruction. The character instruction may be received through the user interface 210 or may otherwise be received. For example, if the user selects an up button on the user interface 210 (see FIG. 2), the user interface module 708 receives the character instruction to move the character up and the attribute selection module 704 selects the character attribute that is associated with projecting the character image of the character in an up position.

In one embodiment, the user interface module 708 receives the user play set instruction through the user interface 210. The user play set instruction is a request received by the user to interact with the electronic play set 104. The play set communication module 706 then transmits the play set query to the electronic play set 104 in response to receiving the user play set instruction.

Notifications may be provided through use of the notification module 710. The notification may alert the user of the mobile electronic projection device 102 of a certain event. In one embodiment, the notification module 710 provides a notification based on the play set communication module 706 receiving the play set response. A user character instruction may then be received through the user interface 210 by the user interface module 708 on the mobile electronic projection device 102.

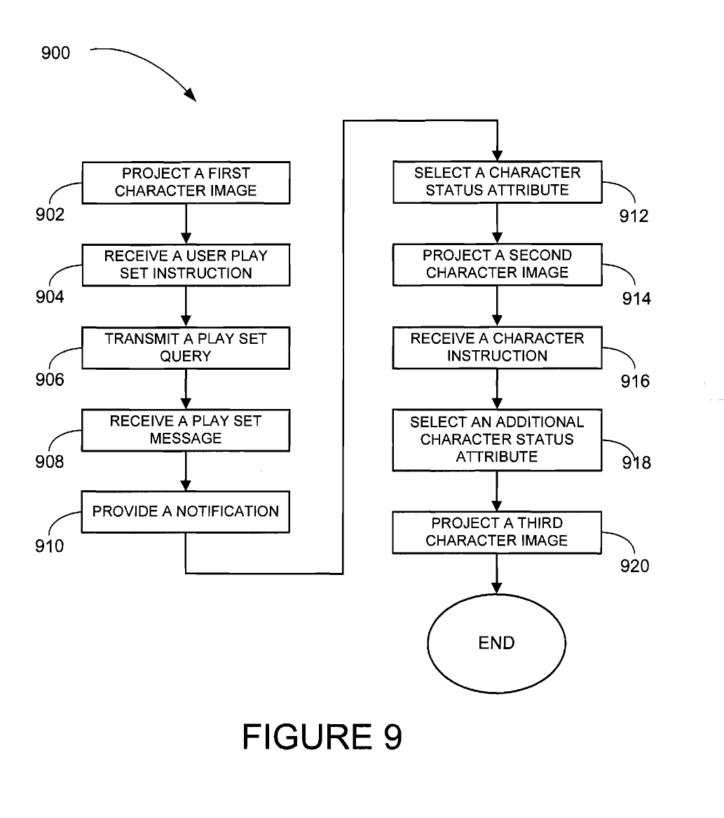

FIG. 8 illustrates a method 800 for character image projection according to an example embodiment. The method 800 may be performed by the mobile electronic projection device 102 of the system 100 (see FIG. 1), or may otherwise be performed. In this method, different character images of the character are projected on a surface. The character image changes based on selection of a different character attribute.

At block 802, a first character image associated with a first character attribute is projected onto a surface. The first character image includes a first graphical representation of the character. The first character attribute represents the first character status of the character in the first character image.

In some embodiments, the character instruction is received at block 804. The character instruction may be received through the user interface 202 (see FIG. 2), or may otherwise be received.

A second character attribute is selected at block 806 based on the character instruction. The second character attribute represents a changed character status of the character in the second character image. The selection may include altering the first character attribute to create the second character attribute.

At block 808, a second character image is projected onto the surface based on selection of the second image attribute. The second character image includes a second graphical representation of the character. The second graphical representation is a different graphical representation of the character than the first graphical representation. The second graphical representation may be accessed from preexisting character images or may be generated based on the selection of the second character attribute.

FIG. 9 illustrates a method 900 for character image projection, according to an example embodiment. The method 900 may be performed by the mobile electronic projection device 102 of the system 100 (see FIG. 1), or may otherwise be performed. In this method, different character images of the character are projected on the surface of the electronic play set 104.

At block 902, a first character image associated with a first character attribute is projected. The first character image may be projected onto the surface of the electronic play set 104, or may otherwise be projected.

In some embodiments, a user play set instruction is received at block 904 through the user interface 210.

The play set query may be transmitted to the electronic play set 104 at block 906. In some embodiments, the play set query is transmitted from the play set interface 208 to the device communication interface 404 (see FIGS. 2 and 4). The play set query may be transmitted in response to receipt of the user play set instruction.

The play set message is received from the electronic play set 104 in response to transmitting the play set query at block 908. In some embodiments, the play set message includes a play set identifier.

In some embodiments, the notification is provided at block 910 based on receiving the play set response. A user character instruction may then be received through the user interface 202 in response to providing the notification.

A second character attribute is selected at block 912. In some embodiments, the second character attribute is selected based on receipt of the play set message from the electronic play set 104 and the user character instruction through the user interface 202.

At block 914, a second character image is projected based on selection of the second image attribute. The second character image may be projected onto the surface of the electronic play set 104, or may otherwise be projected.

An additional character instruction may be received at block 916.

A third character attribute on the mobile electronic device may be selected at block 918 based on the additional character instruction. The third character attribute represents a different character status of the character in a third character image than the character in the second character image.

The third character image may be projected at block 920 based on selection of the third character image attribute. The third character image includes a third graphical representation of the character. The third graphical representation is a different graphical representation of the character than the second graphical representation. The third character image may be projected onto the surface of the electronic play set 104, or may otherwise be projected.

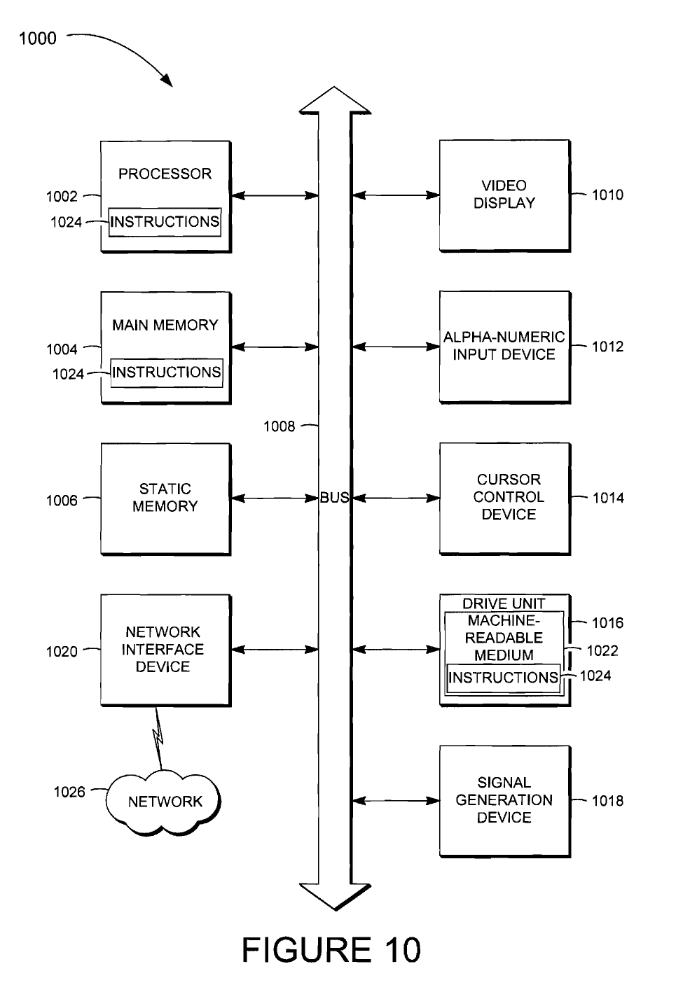

FIG. 10 shows a block diagram of a machine in the example form of a computer system 1000 within which a set of instructions may be executed causing the machine to perform any one or more of the methods, processes, operations, or methodologies discussed herein. The mobile electronic projection device 102, the electronic play set 104, or both (see FIG. 1) may include at least a portion of the functionality of the one or more computer systems 1000.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, a kiosk, a point of sale (POS) device, a cash register, an Automated Teller Machine (ATM), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1012 (e.g., a central processing unit (CPU) a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a cursor control device 1014 (e.g., a mouse), a drive unit 1016, a signal generation device 1018 (e.g., a speaker) and a network interface device 1020.

The drive unit 1016 includes a machine-readable medium 1022 on which is stored one or more sets of instructions (e.g., software 1024) embodying any one or more of the methodologies or functions described herein. The software 1024 may also reside, completely or at least partially, within the main memory 1004 and/or within the processor 1012 during execution thereof by the computer system 1000, the main memory 1004 and the processor 1012 also constituting machine-readable media.

The software 1024 may further be transmitted or received over a network 1026 via the network interface device 1020.

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing or encoding a set of instructions for execution by the machine and that cause the machine to perform any one or more of the methodologies of the present invention. The term “machine-readable medium” shall accordingly be taken to include, but not be limited to, solid-state memories, and optical media, and magnetic media. In some embodiments, the machine-readable medium is a non-transitory machine-readable medium.

The inventive subject matter may be represented in a variety of different embodiments of which there are many possible permutations. In one embodiment, a first character image associated with a first character attribute may be projected. The first character image includes a first graphical representation of a character. The first character attribute may represent a character status of the character in the first character image. A second character attribute is selected based on a character instruction. The second character attribute may represent a changed character status of the character in the second character image. A second character image from the mobile electronic device may be projected based on selection of the second image attribute.

Thus, methods and systems for character image projection have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The methods described herein do not have to be executed in the order described, or in any particular order. Moreover, various activities described with respect to the methods identified herein can be executed in serial or parallel fashion. Although “End” blocks are shown in the flowcharts, the methods may be performed continuously.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separate embodiment.

1. A method comprising:
projecting from a mobile electronic device a first character image associated with a first character attribute, the first character image including a first graphical representation of a character, the first character attribute representing a character status of the character in the first character image;
selecting a second character attribute on the mobile electronic device based on a character instruction, the second character attribute representing a changed character status of the character in the second character image; and
projecting a second character image from the mobile electronic device based on selection of the second image attribute, the second character image including a second graphical representation of the character, the second graphical representation being a different graphical representation of the character than the first graphical representation.

2. The method of claim 1, further comprising:
transmitting a play set query from an active sensor of the mobile electronic device to the active sensor of a play set; and
receiving a play set message from the play set in response to transmitting the play set query,
wherein the character instruction is based on the play set message.

3. The method of claim 2, further comprising:
selecting the character instruction based on the play set message.

4. The method of claim 2, wherein the play set message includes the character instruction.

5. The method of claim 2, wherein the play set message includes a play set identifier.

6. The method of claim 2, further comprising:
receiving a user play set instruction through a user interface on the mobile electronic device,
wherein transmitting the play set query is in response to receiving the user play set instruction.

7. The method of claim 2, further comprising:
providing a notification on the mobile electronic device based on receiving the play set response;
receiving a user character instruction through a user interface on the mobile electronic device in response to providing the notification,
wherein selecting the second character attribute on the mobile electronic device is based on receipt of the play set message from the play set and the user character instruction through the user interface.

8. The method of claim 2, further comprising:
receiving an additional character instruction on the mobile electronic device;
selecting a third character attribute on the mobile electronic device based on the additional character instruction, the third character attribute representing a different character status of the character in a third character image than the character in the second character image;
projecting the third character image from the mobile electronic device based on selection of the third character image attribute, the third character image including a third graphical representation of the character, the third graphical representation being a different graphical representation of the character than the second graphical representation.

9. The method of claim 1, further comprising:
receiving the character instruction on the mobile electronic device,
wherein selecting the second character attribute on the mobile electronic device is based on receipt of the character instruction.

10. The method of claim 9, wherein the character instruction is received through a user interface on the mobile electronic device.

11. The method of claim 9, wherein selecting the second character attribute includes:
altering the first character attribute to create the second character attribute based on receipt of the user instruction.

12. The method of claim 1, further comprising:
accessing the second character image based on selection of the second character attribute,
wherein projecting the second character image is based on accessing the second character image.

13. The method of claim 1, wherein the character status includes a position of the character in the first character image, a geographic location of the character, a pose of the character, an association of a background with the character, an association of an item with the character, an item status of the item associated with the character, or combinations thereof.

14. A machine-readable non-transitory medium comprising instructions, which when executed by one or more processors, cause the one or more processors to perform the following operations:
project from a mobile electronic device a first character image associated with a first character attribute, the first character image including a first graphical representation of a character, the first character attribute representing a character status of the character in the first character image;
select a second character attribute on the mobile electronic device based on a character instruction, the second character attribute representing a changed character status of the character in the second character image; and
project a second character image from the mobile electronic device based on selection of the second image attribute, the second character image including a second graphical representation of the character, the second graphical representation being a different graphical representation of the character than the first graphical representation.
